(19) United States
(12) Patent Application Publication
(10) Pub. No.: US 2023/0121175 A1
(43) Pub. Date: Apr. 20, 2023

(54) Pulling rivet for fastening connection of conductive material

(71) Applicant: MEISHAN CRRC FASTENING SYSTEM CO., LTD, Meishan City, Sichuan (CN)

(72) Inventors: XU HE, Meishan City, Sichuan (CN); YUNLONG JIA, Meishan City, Sichuan (CN); CHUANQI LI, Meishan City, Sichuan (CN); SHIBO WANG, Meishan City, Sichuan (CN); QIN ZHANG, Meishan City, Sichuan (CN); SHUAI DONG, Meishan City, Sichuan (CN); ZONGYANG ZUO, Meishan City, Sichuan (CN); YU LIU, Meishan City, Sichuan (CN); TAO DENG, Meishan City, Sichuan (CN); JUAN JIANG, Meishan City, Sichuan (CN)

(21) Appl. No.: 16/976,064

(22) PCT Filed: May 26, 2020
(86) PCT No.: PCT/CN2020/092250

§ 371 Date: Aug. 26, 2020

(30) Foreign Application Priority Data
Nov. 28, 2019 (CN) 201911187964.0

(51) Int. Cl. F16B 19/05; F16B 1/00

(52) U.S. Cl. CPC F16B 19/05; F16B 1/00; F16B 2001/0064

(57) ABSTRACT

The invention discloses a pulling rivet for fasten-connecting a conductive material. It consists of a rivet and a lantern ring, wherein the rivet comprises a dead head, a polish rod, a locking groove, a pulling groove and a short tail, the lantern ring comprises a flange, a deformation area and a clamping tooth, and a sharp protrusion is arranged on a contact surface of an inner side of the dead head and a fasten-coupling piece. The sharp protrusions of the present invention can be embedded into the surface of the fastening piece to prevent the sliding between the fasten-coupling piece and the rivet, and because the sharp protrusions are embedded into the surface of the fasten-coupling piece to form a tightly fitted whole, which improves the conductivity of the rivet and the frame.

### TECHNICAL FIELD

The invention belongs to the technical field of riveting, and in particular to the design and manufacture of a pulling rivet riveting fastener for connecting a conductive material, which belongs to the riveting category (B21J) and the fastener category (F16B) for metal machining.

### BACKGROUND ART

A pulling rivet is a commonly used fasten-coupling piece in existing fastening coupling methods, and is generally used for coupling of components that require bolting or riveting. When the fastening operation is used, two to-be-combined pieces are clamped by the special equipment for pulling rivet, after which metal of the sleeved annular lantern ring is extruded, and pits of a plurality of annular grooves of the bolt column are filled, so that the lantern ring and the bolt column are tightly combined and fastened. The pulling rivet fastener has such features as the same fastening force and never loosing after assembly.

The existing pulling rivet is simple in fastening and simplex in function, where the pulling rivet and the coupling pieces often complete only the simple fastening coupling after the fastening operation, with no requirement for further combination of the pulling rivet and the fasten-coupling pieces. In the coupling process of the solar cell panels, it is not only necessary to fasten couple the coupling plates, but also to further improve the electrical conductivity of the coupling part; and often due to the fact that an oxide film, a corrosion layer and the like on the surface of the coupling metal piece reduce the conductive performance, the fastening coupling that utilizes planar contact cannot meet the coupling process requirement of the existing cell panels.

### SUMMARY OF THE INVENTION

The present invention addresses the deficiencies of the prior art by disclosing a pulling rivet for fastening connection of a conductive material. The invention aims to solve the problem of providing a pulling rivet for fasten-connecting a conductive material, which can improve the conductivity between the coupling metal pieces and has better performance for fastening connection of a conductive material.

The present invention is achieved by the following technical solution:

A pulling rivet for fasten-connecting a conductive material consists of a rivet and a lantern ring, wherein the rivet comprises a dead head, a polish rod, a locking groove, a pulling groove and a short tail, and the lantern ring comprises a flange, a deformation area and a clamping tooth, which is characterized in that: a sharp protrusion is arranged on a contact surface of an inner side of the dead head and a fasten-coupling piece.

A height of the protrusion is ⅕˜ 1/12 of the thickness of the dead head.

One configuration of the protrusion of the present invention is a plurality of independent tooth-like protrusions uniformly disposed on the contact surface of the inner side of the dead head and the fasten-coupling piece.

Another configuration of the protrusion of the present invention is 1 or 2 ring-shaped protrusions surrounding the contact surface of the inner side of the dead head and the fasten-coupling piece.

The protrusion according to the present invention may also comprise a plurality of independent tooth-like protrusions uniformly disposed on the contact surface of the inner side of the dead head and the fasten-coupling piece and ring-shaped protrusion(s) surrounding the contact surface of the inner side of the dead head and the fasten-coupling piece.

The pulling rivet of the present invention is used for an aluminum alloy conductive material.

The pulling rivet of the present invention, when applied to the fastening connection of a conductive material, can further improve the conductive performance, and prevent damage caused by the exerted overlarge twisting torque when implementing the fastening connection of the pulling rivet due to the fact that the fasten-coupling piece is relatively thin.

When the pulling rivet of the present invention is used for the fastening connection of the aluminum alloy frame for a solar cell panel, since the aluminum alloy frame material is soft, the plate is often crushed and scrapped due to the exerted overlarge twisting torque. Meanwhile, due to different potential differences between the carbon steel and aluminum alloy materials, electrochemical corrosion occurs in the application process, thus leading to connection failure, bolts fall-off and the like. When using an aluminum alloy bolt to fasten-connect the aluminum alloy frame, because the strength of the aluminum alloy bolt is relatively low, the aluminum alloy frame and the bolt cannot be completely fitted after being twisted, and when encountering a strong current, the gap between the bolt and the aluminum alloy plate causes discharge, which thus leads to damage of the frame or the bolt, and cannot guarantee the safety of its components.

In the present invention, sharp protrusions with strength are arranged on the inner side of the rivet, and after the fastening connection, the sharp protrusions are embedded into the surface of the fastening piece, which not only prevents the sliding between the fasten-connecting piece and the rivet, but also because the sharp protrusions are embedded into the surface of the fasten-connecting piece, for example, after piercing the aluminum alloy plate, they pierce the oxide film or anode oxide film formed by the metal and oxygen on the surface of the aluminum alloy, so that the rivet and the aluminum alloy material become a tightly fitted whole, thus improving the conductivity of the rivet and the frame. This effectively solves the problems of electrochemical corrosion, plate damage, poor conductivity and the like during the fastening connection of the aluminum alloy frame, and guarantees safe operation of the solar photovoltaic system.

### BRIEF DESCRIPTION OF THE DRAWINGS

FIG. 1 is a schematic view of the structure of a rivet of the present invention;

FIG. 2 is a schematic view of the structure of a lantern ring of the present invention;

FIG. 3 is a schematic view showing the structure of the inner side of the rivet dead head according to a first embodiment;

FIG. 4 is a schematic view of a cross-sectional structure of the rivet according to a first embodiment;

FIG. 5 is a schematic view showing the structure of the inner side of the rivet dead head according to a second embodiment;

FIG. 6 is a schematic view of a cross-sectional structure of the rivet according to a second embodiment.

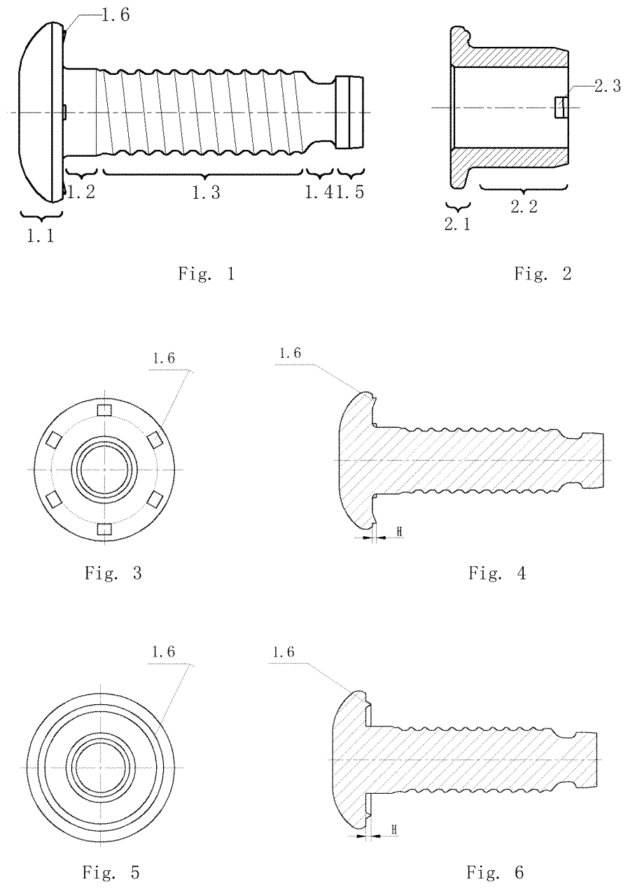

In the drawings, 1.1 is a dead head, 1.2 is a polish rod, 1.3 are locking grooves, 1.4 is a pulling groove, 1.5 is a short tail, 1.6 is a protrusion, 2.1 is a flange, 2.2 is a deformation area, 2.3 is a clamping tooth, and H is a height of the protrusion.

### DETAILED DESCRIPTION OF THE INVENTION

The invention will now be further described with reference to specific embodiments which are further illustrative of the principles of the invention and are not intended to limit the invention in any way, and the same or similar techniques as or to the invention do not exceed the scope of the invention.

In connection with the drawings As shown in the drawings, a pulling rivet for fasten-connecting a conductive material consists of a rivet and a lantern ring, wherein the rivet comprises a dead head 1.1, a polish rod 1.2, locking grooves 1.3, a pulling groove 1.4 and a short tail 1.5, and the lantern ring comprises a flange 2.1, a deformation area 2.2 and a clamping tooth 2.3; in the present invention, a sharp protrusion 1.6 is arranged on the contact surface between the inner side of the dead head 1.1 and the fasten-coupling piece.

A height of the protrusion 1.6 provided by the present invention is ⅕˜ 1/12 of the thickness of the dead head 1.1.

The rivet and the lantern ring may be manufactured from an aluminum alloy material.

The rivet is applied with solid solution aging treatment, and a cleaning treatment should be carried out on the surface; the lantern ring is applied with softening treatment to be suitable for cold extrusion riveting.

For the pulling rivet, a conventional installation method is employed, wherein the height H of the protrusion should be ⅕˜ 1/12 of the thickness of the dead head 1.1, so that it pierces the conductive material being connected and does not cause excessive damage to the conductive material to reduce its strength. After the protrusion 1.6 is embedded into the conductive plate, it can prevent the relative sliding between the rivet dead head and the connected piece, thus improving the strength of the fastening connection; meanwhile, it pierces the oxide film or anode oxide film formed by the metal and oxygen on the surface of the conductive material, so that the rivet and the conductive material become a tightly fitted whole, thus improving the conductivity of the entirety.

The protrusion of the present invention may have a variety of configurations and the following embodiments are merely illustrative of the application thereof.

### Embodiment 1

As shown in FIGS. 3 and 4, FIG. 3 is a schematic view of the structure of the inner side of the rivet dead head in embodiment 1; FIG. 4 is a schematic view of a cross-sectional structure of the rivet of embodiment 1. In the figure, six protrusions 1.6 are arranged at even intervals on the contact surface of the inner side of the dead head 1.1 and the fasten-coupling piece, wherein the protrusions 1.6 are in a sharp structure, and have a height that is ⅕˜ 1/12 of the thickness of the dead head 1.1.

### Embodiment 2

As shown in FIGS. 5 and 6, FIG. 5 is a schematic view of the structure of the inner side of the rivet dead head in embodiment 2; FIG. 6 is a schematic view of a cross-sectional structure of the rivet of embodiment 2. In the figure, a ring-shaped protrusion 1.6 is arranged surrounding the contact surface of the inner side of the dead head 1.1 and the fasten-coupling piece, wherein the protrusion 1.6 is in a sharp structure, and has a height that is ⅕˜½ of the thickness of the dead head 1.1.

1. A pulling rivet for fasten-connecting a conductive material consisting of a rivet and a lantern ring, wherein the rivet comprises a dead head, a polish rod, a locking groove, a pulling groove and a short tail, and the lantern ring comprises a flange, a deformation area and a clamping tooth, characterized in that: a sharp protrusion is arranged on a contact surface of an inner side of the dead head and a fasten-coupling piece.

2. The pulling rivet for fasten-connecting a conductive material according to claim 1, characterized in that: a height of the protrusion is ⅕˜ 1/12 of the thickness of the dead head.

3. The pulling rivet for fasten-connecting a conductive material according to claim 2, characterized in that: the protrusion is a plurality of independent tooth-like protrusions uniformly arranged on the contact surface of the inner side of the dead head and the fasten-coupling piece.

4. The pulling rivet for fasten-connecting a conductive material according to claim 2, characterized in that: the protrusion is 1 or 2 ring-shaped protrusions surrounding the contact surface of the inner side of the dead head and the fasten-coupling piece.

5. The pulling rivet for fasten-connecting a conductive material according to claim 2, characterized in that: the protrusion comprises a plurality of independent tooth-like protrusions uniformly disposed on the contact surface of the inner side of the dead head and the fasten-coupling piece, and the ring-shaped protrusion(s) surrounding the contact surface of the inner side of the dead head and the fasten-coupling piece.

6. The pulling rivet for fasten-connecting a conductive material according to claim 1, characterized in that: the conductive material is an aluminum alloy material.

7. The pulling rivet for fasten-connecting a conductive material according to claim 2, characterized in that: the conductive material is an aluminum alloy material.

8. The pulling rivet for fasten-connecting a conductive material according to claim 3, characterized in that: the conductive material is an aluminum alloy material.

9. The pulling rivet for fasten-connecting a conductive material according to claim 4, characterized in that: the conductive material is an aluminum alloy material.

10. The pulling rivet for fasten-connecting a conductive material according to claim 5, characterized in that: the conductive material is an aluminum alloy material.
